(19) United States
(12) Patent Application Publication
(10) Pub. No.: US 2010/0246096 A1
(43) Pub. Date: Sep. 30, 2010

(54) USE OF CONJUGATED OLIGOMER AS ADDITIVE FOR FORMING CONDUCTIVE POLYMERS

(76) Inventors: Qingping Chen, Simpsonville, SC (US); Keith R. Brenneman, Simpsonville, SC (US); Yuhong Ma, Beijing (CN); Yongjian Qiu, Greenville, SC (US); Philip M. Lessner, Newberry, SC (US); Randy S. Hahn, Simpsonville, SC (US)

Correspondence Address: NEXSEN PRUET, LLC, P.O. BOX 10648, GREENVILLE, SC, 29603, US

(21) Appl. No.: 12/783,022

(22) Filed: May 19, 2010

Related U.S. Application Data
(62) Division of application No. 11/803,952, filed on May 16, 2007.

(51) Int. Cl. H01G 9/042; H01G 9/07; H01G 9/045

(52) U.S. Cl. 361/524; 361/508; 361/509

(57) ABSTRACT

A process for forming a capacitor. The process includes providing an anode; providing a dielectric on the anode; exposing the anode to a polymer precursor solution comprising monomer, conjugated oligomer and optionally solvent and polymerizing the polymer precursor. The ratio between monomer and conjugated oligomer ranges from 99.9/0.1 to 75/25 by weight. The solvent content in the polymer precursor solution is from 0 to 99% by weight.

### FIELD OF THE INVENTION

This invention relates to methods for improving the conductivity of intrinsically conductive organic polymers and capacitors prepared by using such methods which exhibit reduced equivalent series resistance (ESR) and robust performance during the surface mounting process of the capacitor to a circuit board. More specifically, the invention relates to a method of forming a capacitor wherein a conductive polymer is formed by a combination of monomers, and conjugated oligomers with no more than five repeating units.

### BACKGROUND OF THE INVENTION

Electrolytic capacitors having valve metal anodes impregnated with a highly conductive liquid electrolyte such as an aqueous solution of sulfuric acid have been in commercial use for many years. There are many liquid electrolyte solutions which have been used in electrolytic capacitors. The liquid electrolytes conduct current by an ionic conduction mechanism and tend to have high resistance. Haring et. al., in U.S. Pat. No. 3,093,883, disclosed the use of pyrolytic manganese dioxide produced via the pyrolysis of aqueous manganese nitrate solutions as the cathode material. Manganese dioxide as a solid state conductor with lower resistivity (1-3 orders of magnitude lower than liquid electrolyte solutions) substantially reduced the resistance of the cathode layer and overall resistance of these devices.

With the continuing development of ever-faster microprocessors and lower-voltage logic circuits, the demand for lower ESR capacitors for use in conjunction with faster microprocessors has motivated capacitor manufacturers to develop solid state cathode materials which are more conductive, less electrically resistive, than manganese dioxide.

In the early 1980's, electrolytic capacitors were introduced which were fabricated having a tetracyanoquinodimethane amine complex acting as the cathode. These capacitors established the stability and high conductivity achievable with solid-state organic cathode materials. The ongoing effort to increase the maximum temperature capability of organic cathode electrolytic capacitors has led to the development of methods of capacitor fabrication employing intrinsically conductive organic polymers, such as polypyrrole, polythiophenes, polyanilines and their derivatives. Numerous substituted monomers, or derivatives, are useful as are mixtures of two or more monomers from different types, i.e., mixtures. High electric conductivity, good thermal stability and benign failure mode led to the widespread use of these intrinsically conductive organic polymers in solid electrolytic capacitors since the 1990s.

Both chemical and electrochemical polymerization has been used to form intrinsically conductive polymers for electrolytic capacitors. Chemical polymerization is well described in U.S. Pat. No. 4,910,645, to Jonas et. al., U.S. Pat. No. 6,136,176 to D. Wheeler, et. al. and U.S. Pat. No. 6,334,966 to Hahn et al. The process consists of immersing the anodized substrate first in a solution of an oxidizing agent such as, but not necessarily limited to, iron (III) p-toluenesulfonate. After a drying step the anode bodies are then immersed in a solution of the monomer. Once the solution of monomer, which may consist entirely of monomer, is introduced into the capacitor anode bodies, the anodes are allowed to stand to facilitate production of the intrinsically conductive polymer material. Repeated dipping sequences may be employed to more completely fill the pore structure of the anode bodies. In practice, rinsing cycles are generally employed to remove reaction by-products, such as ammonium sulfate, sulfuric acid, iron salts (when an iron (III) oxidizer is employed), or other by-products depending on the system employed. Chemical production of intrinsically conductive organic polymers may also be carried-out with capacitor anode bodies by first introducing the monomer to the capacitor bodies, followed by introduction of the oxidizer and dopant (the reverse order of polymer precursor introduction described above). It is also possible to mix the dopant acid(s) with the monomer solution rather than with the oxidizer solution if this is found to be advantageous. U.S. Pat. Nos. 6,001,281 and 6,056,899 describe a chemical means of producing an intrinsically conductive organic polymer through the use of a single solution which contains both the monomer and the oxidizing agent, which has been rendered temporarily inactive via complexing with a high vapor pressure solvent. As the solution is warmed and the inhibiting solvent evaporates, the oxidative production of conductive polymers ensues. The dopant acid anion is also contained in the stabilized poly-precursor solution.

The demand for capacitors exhibiting lower equivalent series resistance (ESR) and dissipation factor, which has led to the development of electrolytic capacitors based on conductive polymer cathode materials, has been accompanied by a demand for capacitors exhibiting higher reliability, particularly a lower incidence of high leakage current/short circuit failures.

Intrinsically conductive organic polymers generally contain one dopant anion for each 3 to 4 monomer units which have been joined to form the polymer. The presence of a strong dopant acid anion is thought to result in a delocalization of electric charge on the conjugated molecular chain and therefore provides electrical conductivity. In the case of ferric salt being used as the oxidizer, the presence of an acid also keeps the Fe³⁺ ions from precipitating out of the solution. In the sequential dipping process the acid could accumulate in the monomer solution. It is known that an acid can promote the formation of non-conjugated dimers and trimers through acid catalyzed reaction. U.S. Pat. No. 6,891,016 to Rueter et al. disclosed the formation of non-conjugated ethylenedioxythiophene (EDT) dimer, structure (I), and trimer, structure (II), in the presence of an acid catalyst.

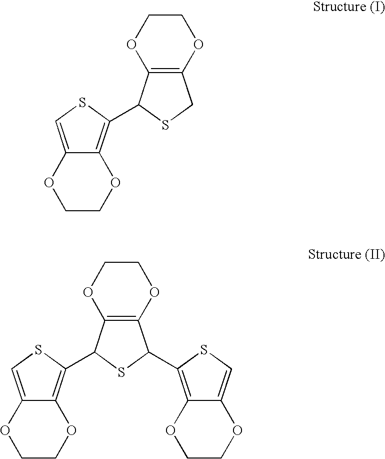

These non-conjugated dimers and trimers can result in a decrease in conjugation length which deteriorates conductivity of the polymer. This would cause an increase in ESR of conductive polymer based solid electrolytic capacitors. In US patent application (docket number 31433-117 filed Apr. 16, 2007) procedures to control the acid content in the monomer solution are disclosed. Although the conductivity of polymer made according to US patent application (docket number 31433-117 filed Apr. 16, 2007) was maintained high, the growth rate of the conductive polymer could be decreased. More production cycles may be required to provide adequate polymer coverage.

There has been an ongoing, and increasing, desire to provide a conductive polymer layer with improved conductivity. There has also been a desire to provide a capacitor, comprising the conductive polymer, with an improved ESR and reliability.

### SUMMARY OF THE INVENTION

It is an object of the present invention to provide an improved polymer coating as indicated by a reduced resistance.

It is another object of the present invention to provide an improved capacitor wherein the capacitor has a lower ESR due to a lower resistance in the polymeric cathode layer.

A particular advantage of the present invention is the ability to implement the improvement with minimal alterations to existing manufacturing facilities or processes.

These and other advantages, as will be understood, are provided in a process for forming a capacitor. The process includes providing an anode; providing a dielectric on the anode such as by anodizing the anode; exposing, such as by dipping, the anode into a polymer precursor solution comprising monomers, conjugated oligomers and optionally solvents and polymerizing the polymer precursor. The ratio of monomers to conjugated oligomers ranges from 99.9/0.1 to 75/25 by weight, the solvent content of the solution of polymer precursor is from 0 to 99% by weight.

A preferred embodiment is provided in a capacitor formed by the process of: providing an anode; forming a dielectric on the anode; exposing the anodized anode into a polymer precursor solution comprising monomer, conjugated oligomer and optionally solvent and polymerizing the polymer precursor. The ratio between monomers and conjugated oligomers ranges from 99.9/0.1 to 90/10 by weight, the solvent content in the solution of precursors is preferably from 10-90% by weight.

A particularly preferred embodiment is provided in a process for forming a capacitor comprising: providing an anode comprising a material selected from niobium, aluminum, tantalum, titanium, zirconium, hafnium, tungsten and NbO; forming a dielectric on the anode to form an anodized anode; dipping the anodized anode into a polymer precursor solution comprising monomer, conjugated oligomers and optionally solvents to form a polymer precursor coating and polymerizing the polymer precursor coating. The ratio of monomers to conjugated oligomers ranges from 99.9/0.1 to 75/25 by weight and the solvent content in the solution of precursor is from 0 to 99% by weight with the monomer defined as:

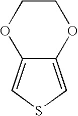

and the conjugated oligomer is defined as:

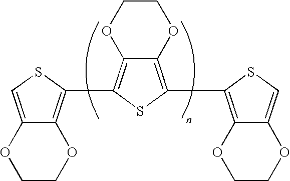

where n=0 to 3.

### BRIEF DESCRIPTION OF DRAWINGS

FIG. 1 is a schematic cross-sectional view of a capacitor of the present invention.

FIGS. 2a and 2b provide Fourier transform infrared (FT-IR) spectra of conjugated and nonconjugated EDT dimmers, respectively.

FIGS. 3a and 3b provide proton nuclear magnetic resonance (¹H NMR) spectra of conjugated and nonconjugated EDT dimmers, respectively.

FIG. 4 provides a ¹H NMR spectrum of an EDT sample used to make poly-EDT (PEDT).

FIG. 5 provides scanning electron microscope (SEM) pictures after deposition of polymer from various solutions.

### DETAILED DESCRIPTION

An improvement in a conductive polymer, and capacitor formed with the conductive polymer, is achieved by adding conjugated oligomer, preferably conjugated dimer or conjugated trimer, to the monomer solution. The addition of conjugated oligomer provides adequate polymer growth rate for good polymer coverage of the dielectric surface of the anode.

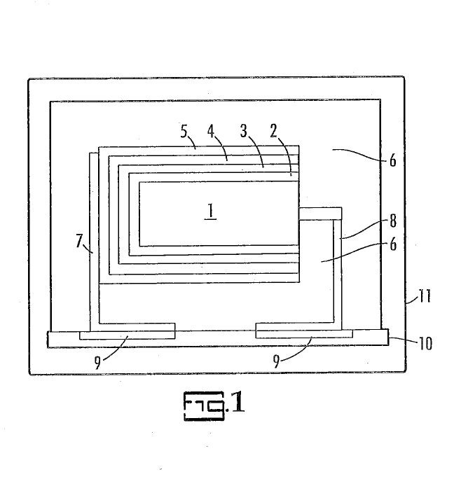

The invention will be described with reference to the FIG. 1 forming a part of the present application.

In FIG. 1, a cross-sectional view of a capacitor is shown. The capacitor comprises an anode, 1. A dielectric layer, 2, is provided on the surface of the anode, 1. The dielectric layer is preferably formed as an oxide of the anode as further described herein. Coated on the surface of the dielectric layer, 2, is a conducting layer, 3. Layers 4 and 5 are conductive coating layers comprising graphite and silver based materials and providing connection to lead 7. Leads, 7 and 8, provide contact points for attaching the capacitor to a circuit. The entire element, except for the terminus of the leads, is then preferably encased in a housing, 6, which is preferably an epoxy resin housing. The capacitor may be attached to circuit traces, 9, of a substrate, 10, and incorporated into an electronic device, 11.

The anode is a conductive material preferably comprising a valve-metal preferably selected from niobium, aluminum, tantalum, titanium, zirconium, hafnium, or tungsten or a conductive oxide such as NbO. Aluminum, tantalum, niobium and NbO are most preferred as the anode material. Aluminum is typically employed as a foil while tantalum, niobium and NbO are typically prepared by pressing a powder and sintering to form a compact. For convenience in handling, the anode is typically attached to a carrier thereby allowing large numbers of elements to be processed at the same time.

The anode in the form of a foil is preferably etched to increase the surface area. Etching is preferably done by immersing the anode into at least one etching bath. Various etching baths are taught in the art and the method used for etching the valve metal is not limiting herein.

A dielectric is formed on the anode. In a preferred embodiment the surface of the anode is coated with a dielectric layer comprising an oxide. It is most desirable that the dielectric layer be an oxide of the anode material. The oxide is preferably formed by dipping the anode into an electrolyte solution and applying a positive voltage. The process of forming the dielectric layer oxide is well known to those skilled in the art. Other methods of forming the dielectric layer may be utilized such as vapour deposition, sol-gel deposition, solvent deposition or the like. The dielectric layer may be an oxide of the anode material formed by oxidizing the surface of the anode or the dielectric layer may be a material which is different from the anode material and deposited on the anode by any method suitable therefore.

The polymer precursors are polymerized to form the conductive layer which functions as the cathode of the capacitor. The polymer precursors are preferably polymerized by either electrochemical or chemical polymerization techniques with oxidative chemical polymerization being most preferred. In one embodiment the conductive layer is formed by dipping the anodized substrate first in a solution of an oxidizing agent such as, but not necessarily limited to iron (III) p-toluenesulfonate. After a drying step, the anode bodies are then immersed in a solution comprising monomer and oligomer of the conductive polymer and solvents.

The present invention utilizes a polymer precursor comprising a monomer and conjugated oligomer. The monomer preferably represents 75-99.9 wt % of the polymer precursors and the conjugated oligomer represents 0.1-25 wt % of the polymer precursors. More preferably the monomer represents 90-99.9 wt % of the polymer precursors and the conjugated oligomer represents 0.1-10 wt % of the polymer precursors. Even more preferably the monomer represents 95-99.5 wt % of the polymer precursors and the conjugated oligomer represents 0.5-5 wt % of the polymer precursors. The preferred monomer is a compound of Formula I and the preferred oligomer is a compound of Formula II.

The conducting polymer is preferably the polymer comprising repeating units of a monomer and oligomer of Formula I and Formula II:

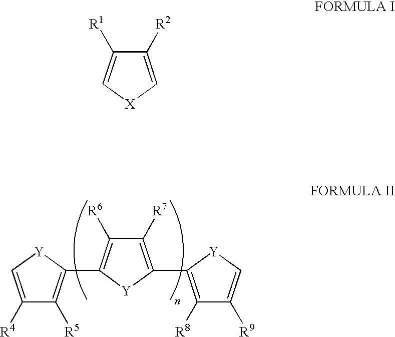

R¹ and R² of Formula I and R⁴-R⁹ of Formula II are chosen to prohibit polymerization at the β-site of the ring. It is most preferred that only α-site polymerization be allowed to proceed. Therefore, it is preferred that R¹ and R² are not hydrogen. More preferably R¹, R², R⁴, R⁵, R⁶, R⁷, R⁸ and R⁹ are α-directors. Therefore, ether linkages are preferable over alkyl linkages. It is most preferred that the groups are small to avoid steric interferences. For these reasons R¹ and R², R⁴ and R⁵, R⁶ and R⁷ or R⁸ and R⁹ taken together as —O—(CH₂)₂—O— are most preferred.

In Formula II n is an integer selected from 0-3.

In Formulas I and II, X and Y independently are S, Se or N. Most preferably X and Y are S.

R¹, R², R⁴, R⁵, R⁶, R⁷, R⁸, and R⁹ independently represent linear or branched C₁-C₁₆ alkyl or C₁-C₁₈ alkoxyalkyl; or are C₃-C₈ cycloalkyl, phenyl or benzyl which are unsubstituted or substituted by C₁-C₆ alkyl, C₁-C₆ alkoxy, halogen or OR³; or R¹ and R², R⁴ and R⁵, R⁶ and R⁷ or R⁸ and R⁹, taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements. R³ preferably represents hydrogen, linear or branched C₁-C₁₆ alkyl or C₁-C₁₈ alkoxyalkyl; or are C₃-C₈ cycloalkyl, phenyl or benzyl which are unsubstituted or substituted by C₁-C₆ alkyl.

More preferably R¹, R², R⁴, R⁵, R⁶, R⁷, R⁸ and R⁹, independently of one another, represent —CH₃, —CH₂CH₃; —OCH₃; —OCH₂CH₃ or most preferably R¹ and R², R⁴ and R⁵, R⁶ and R⁷ or R⁸ and R⁹ are taken together to represent —CH₂CH₂— wherein the hydrogen can be replaced with a solubilizing group, a halide or an alkyl.

Terms and chemical formulas used herein to refer to alkyl or aryl moieties refer to either the substituted or unsubstituted unless specifically stated otherwise. A solvent is defined as a single solvent or a mixture of solvents.

The synthesis of conjugated dimers and trimers is well known in the literature. For example. The dimer of 3,4-ethylenedioxythiophene can be made through Ulmann coupling of the monomers with alkyl lithium and cupric chloride [J. Kagan and S. K. Arora, Heterocycles, 20 (1983) 1937].

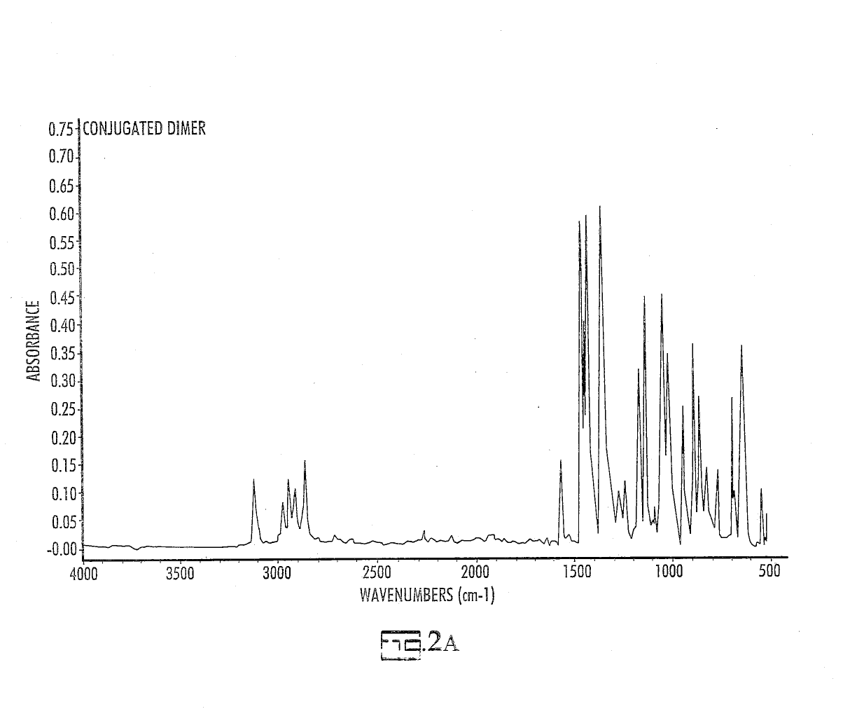

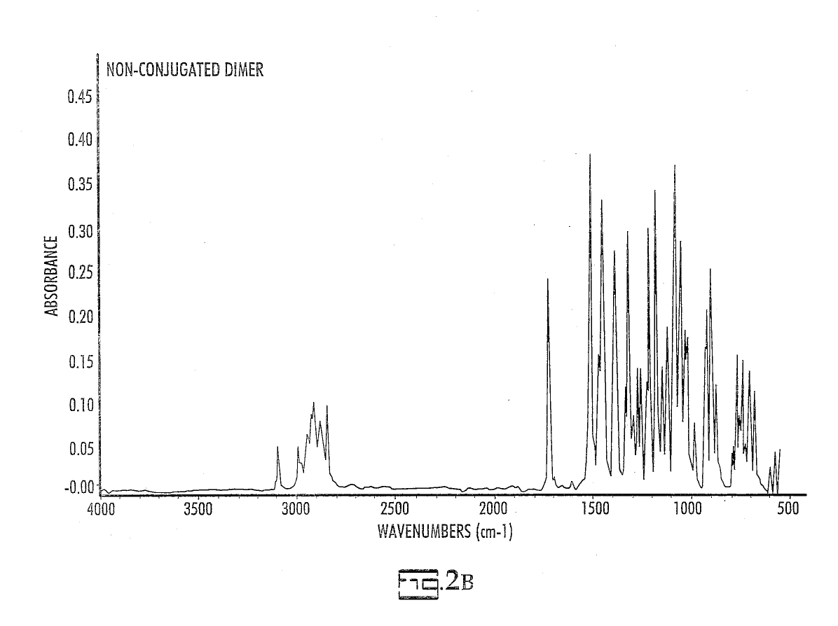

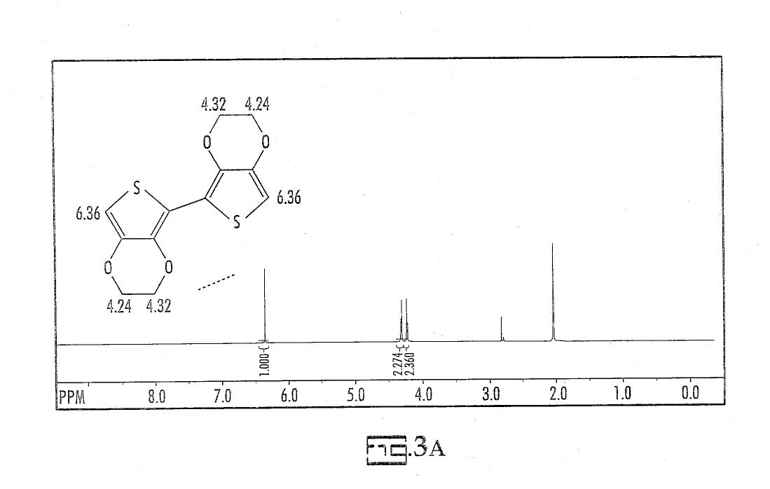

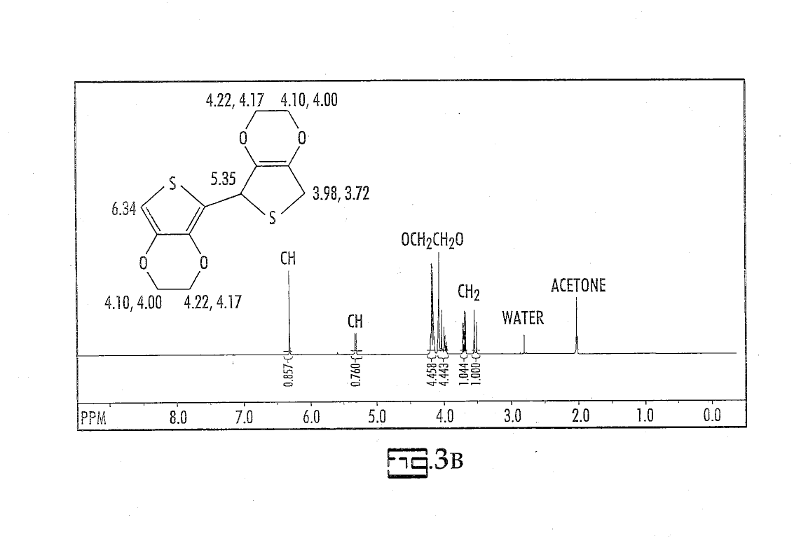

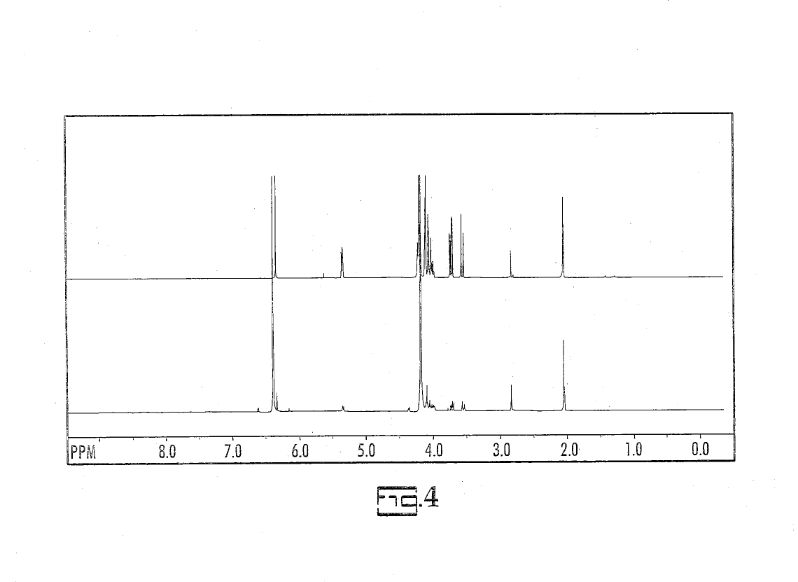

Conjugated and non-conjugated dimers can be distinguished by Fourier transform infrared (FT-IR) spectroscopy as illustrated in FIG. 2, and by nuclear magnetic resonance (NMR) spectroscopy as illustrated in FIG. 3. The presence of nonconjugated dimer in a sample of EDT that was used in the manufacturing dip process of making PEDT onto an anodized Ta surface is shown in FIG. 4. The content of the conjugated as well as non-conjugated dimers in the monomer can be measured by gas chromatograph (GC). Using 3,4-ethylenedioxythiophene (EDT) as an example, the peaks for the monomer, non-conjugated dimer, and conjugated dimer are distinguishable. It is observed over time that the non-conjugated peak (dihydrothiophene) grows in intensity during usage.

A complete coverage of the anodized surface by intrinsically conductive polymer is desired to prevent the graphite and other conductive layers of anode materials from contacting the bare surface of dielectric. When high leakage occurs on the dielectric surface intrinsically conductive polymers would degrade, lose the dopant induced delocalized charges and therefore become non-conductive. Through this mechanism intrinsically conductive polymers provide a self-healing protection similar to MnO₂ based solid electrolytic capacitors where MnO₂ would convert into the non-conductive Mn₂O₃ at elevated temperature.

The polymer coated capacitor anode bodies, coated with an intrinsically conductive organic polymer cathode layer, may then be processed into completed capacitors by coating the conductive polymer cathode coatings with graphite paint, conductive paint comprising conductive fillers such as silver particles, attachment of electrode leads, etc. as is well known to those skilled in the art. The device is incorporated into a substrate or device or it is sealed in a housing to form a discrete mountable capacitor as known in the art.

Other adjuvants, coatings, and related elements can be incorporated into a capacitor, as known in the art, without diverting from the present invention. Mentioned, as a non-limiting summary include, protective layers, multiple capacitive levels, terminals, leads, etc.

### Examples

### Group A

### Controls

150 uF 6V rated anodized tantalum anodes were dipped into a solution of Fe (III) p-toluenesulfonate (oxidant), dried and subsequently dipped into fresh 3,4-ethylenedioxythiophene (monomer) to initiate the polymerization reaction. Polymerization formed a thin layer of conductive polymer (PEDT) on the dielectric surface of the anodes. They were then washed to remove excess monomer and by-products of the reactions. The anodes were then reformed by subjecting to a DC voltage in a diluted phosphoric acid solution to repair any damage to the dielectric and therefore, reducing the DC leakage. This dipping-reforming process cycle was repeated until a thick polymer layer was formed. Scanning electron microscope (SEM) pictures were taken of the anode surface covered with conductive polymer and are shown in FIG. 4.

Carbon and silver coatings were applied onto the anodes by conventional process which is known to those skilled in the art. The parts were then assembled onto leadframes and molded with epoxy based encapsulant. The ESR of the capacitors was measured at 100 KHz. Leakage current under a DC bias was also measured. The number of parts showing short was recorded. The results are listed in Table 1.

### Group B

### Non-Conjugated Dimers as Additive

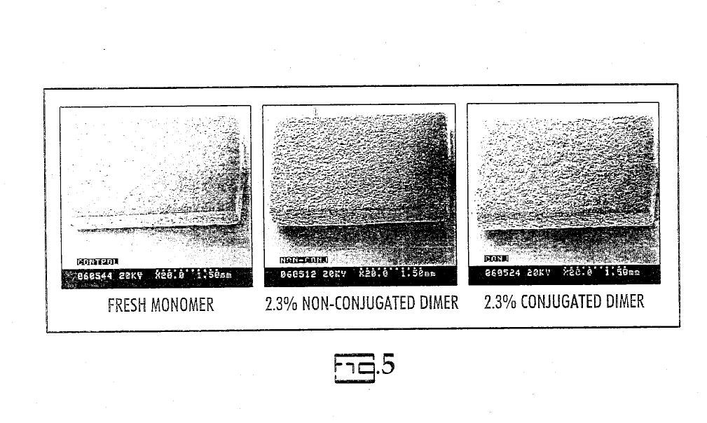

The same type of parts as in Group A were processed the same as Group A with one difference. The fresh monomer used in Group A was replaced with a monomer solution after a large number of dips. It contained 2.3% non-conjugated dimer of EDT as measured by GC. SEM picture of the anode surface covered by conductive polymer is shown in FIG. 5. The ESR and the number of shorts shown after molding are listed in Table 1.

### Group C

### Conjugated Dimers as Additive

The same type of parts as in Group A were processed the same as Group A with one difference. The fresh monomer used in Group A was replaced with a polymer precursor solution containing 2.3% conjugated dimer of EDT. The conjugated dimer was made according to the procedure in the literature [J. Kagan and S. K. Arora, Heterocycles, 20 (1983) 1937]. The polymer precursor solution was made with the conjugated dimer and fresh monomer liquid. SEM picture of the anode surface covered by conductive polymer is shown in FIG. 5. The ESR and the number of shorts shown after molding are listed in Table 1.

The data in Table 1 clearly showed that the addition of conjugated dimer into the monomer improved the polymer growth rate and the polymer coverage of the dielectric surface of the anodes while maintaining a low ESR. The improved coverage in turn helped to reduce the number of shorts.

TABLE 1
ESR Values and Number of Shorts from Control (Group A),
Non-conjugated Dimer Solution in Monomer (Group B) and
Conjugated Dimer Solution in Monomer (Group C)

| | ESR | Number |
|---|---|---|
| | (mΩ) | of Shorts |
| Group A (fresh monomer) | 31.4 | 22 |
| Group B (2.3% non-conjugated dimer) | 42.7 | 14 |
| Group C (2.3% conjugated dimer) | 32.2 | 3 |

*Total number of parts for each group was 333.

This invention has been described with particular reference to the preferred embodiments without limit thereto. Additional embodiments, alterations and improvements could be envisioned without departure from the meets and bounds of the invention as more specifically set forth in the claims appended hereto.

1-17. (canceled)

18. A capacitor formed by the process comprising:
providing an anode;
providing a dielectric on said anode;
exposing said anode comprising said dielectric to a solution of polymer precursor comprising 75-99.9 wt % monomer and 0.1 to 25 wt % conjugated oligomer; and
polymerizing said polymer precursor.

19. An electronic device comprising the capacitor of claim 18.

20-26. (canceled)

27. A capacitor formed by the process of claim 18 wherein said conjugated oligomer is: 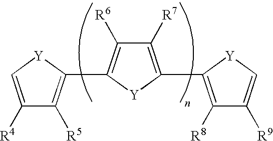
wherein:
Y is independently selected from S, Se and N;
R⁴, R⁵, R⁶, R⁷, R⁸ and R⁹ independently represent hydrogen, linear or branched C₁-C₁₆ alkyl or C₁-C₁₈ alkoxyalkyl; C₃-C₈ cycloalkyl, phenyl or benzyl which are unsubstituted or substituted by C₁-C₆ alkyl, C₁-C₆ alkoxy, halogen or —OR³; or R⁴ and R⁵, R⁶ and R⁷ or R⁸ and R⁹, taken together, are linear C₁-C₆alkylene which is unsubstituted or substituted by C₁-C₆ alkyl, C₁-C₆alkoxy, halogen, C₃-C₈ cycloalkyl, phenyl, benzyl, C₁-C₄ alkylphenyl, C₁-C₄ alkoxyphenyl, halophenyl, C₁-C₄alkylbenzyl, C₁-C₄ alkoxybenzyl or halobenzyl, 5-, 6-, or 7-membered heterocyclic structure containing two oxygen elements.
R³ represents hydrogen, linear or branched C₁-C₁₆ alkyl; C₁-C₁₈ alkoxyalkyl; C₃-C₈ cycloalkyl, phenyl; benzyl which are unsubstituted or substituted by C₁-C₆ alkyl; and
n is an integer selected from 0-3.

28. An electronic device comprising the capacitor of claim 27.

29. A capacitor formed by the process of:
providing an anode;
providing a dielectric on said anode;
exposing said anode comprising said dielectric to a solution comprising polymer precursor comprising 75-99.9 wt % monomer and 0.1 to 25 wt % conjugated oligomer; and
polymerizing said polymer precursor.

30. The capacitor of claim 29 wherein said polymer precursor comprises 90-99.9 wt % monomer and 0.1 to 10 wt % conjugated oligomer.

31. The capacitor of claim 30 wherein said polymer precursor comprises 95-99.5 wt % monomer and 0.5 to 5 wt % conjugated oligomer.

32. The capacitor of claim 29 wherein said anode comprises at least one material selected from niobium, aluminum, tantalum, titanium, zirconium, hafnium, tungsten and NbO.

33. The capacitor of claim 32 wherein said anode comprises at least one material selected from niobium, tantalum and NbO.

34. The capacitor of claim 29 comprising exposing said anode to a solution comprising 1-100% by weight of said polymer precursor and 0-99% by weight solvent.

35. The capacitor of claim 34 comprising 10-90% by weight solvent.

36-38. (canceled)

39. The capacitor of claim 29 wherein said monomer is: 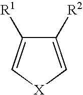
wherein:
X is selected from S, Se and N;
R¹ and R² independently represent hydrogen, linear or branched C₁-C₁₆ alkyl or C₁-C₁₈ alkoxyalkyl; C₃-C₈ cycloalkyl; phenyl or benzyl which are unsubstituted or substituted by C₁-C₆ alkyl, C₁-C₆ alkoxy, halogen or —OR³; or R¹ and R², taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄alkylbenzyl, C₁-C₄ alkoxybenzyl or halobenzyl, 5-, 6-, or 7-membered heterocyclic structure containing two oxygen elements; and
R³ represents hydrogen, linear or branched C₁-C₁₆ alkyl; C₁-C₁₈ alkoxyalkyl; C₃-C₈ cycloalkyl, phenyl; benzyl which are unsubstituted or substituted by C₁-C₆ alkyl.

40. The capacitor of claim 39 wherein neither R¹ nor R² are hydrogen.

41. The capacitor of claim 39 wherein R¹ and R² independently of one another, represent —OCH₃ or —OCH₂CH₃.

42. The capacitor of claim 39 wherein R¹ and R² are taken together to represent —OCH₂CH₂O—.

43. The capacitor of claim 39 wherein X is selected from S and N.

44. The capacitor of claim 43 wherein X is S.

45-51. (canceled)

52. An electronic device comprising the capacitor of claim 29
wherein said conjugated oligomer is: 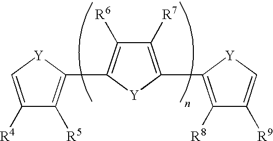
wherein:
Y is independently selected from S, Se and N;
R⁴, R⁵, R⁶, R⁷, R⁸ and R⁹ independently represent hydrogen, linear or branched C₁-C₁₆ alkyl or C₁-C₁₈ alkoxyalkyl; C₃-C₈ cycloalkyl, phenyl or benzyl which are unsubstituted or substituted by C₁-C₆ alkyl, C₁-C₆ alkoxy, halogen or —OR³; or R⁴ and R⁵, R⁶ and R⁷ or R⁸ and R⁹, taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements;
R³ represents hydrogen, linear or branched C₁-C₁₆ alkyl; C₁-C₁₈ alkoxyalkyl; C₃-C₈ cycloalkyl, phenyl; benzyl which are unsubstituted or substituted by C₁-C₆ alkyl; and
n is an integer selected from 0-3.

53-62. (canceled)
